(19) United States
(12) Patent Application Publication
(10) Pub. No.: US 2018/0217910 A1
(43) Pub. Date: Aug. 2, 2018

(54) SCALABLE DATA LOGGING

(71) Applicant: CA, Inc., New York, NY (US)

(72) Inventors: Yang Yang, Newton, MA (US); Patricia Ann Harasta, Westborough, MA (US)

(21) Appl. No.: 15/417,665

(22) Filed: Jan. 27, 2017

(51) Int. Cl. G06F 11/30; G06F 3/06; G06F 11/34; G06F 17/30; G06F 9/50

(52) U.S. Cl. CPC G06F 11/3006; G06F 3/0604; G06F 3/0643; G06F 2201/81; G06F 11/3476; G06F 17/30073; G06F 9/5011; G06F 3/067

(57) ABSTRACT

A scalable data collection and logging system can collect and persist data from a high scale network environment with less strain on memory resources. The system includes data collectors which collect data from network devices and store the data in device-specific logs in memory. The system also includes log monitors which periodically offload and compress the logs in memory and append the logs to device specific log files in storage, thereby freeing up memory space and persisting the log data for future analysis. A log monitor manager load balances offloading operations across available log monitors and can instantiate additional log monitors to scale the offloading operations as a network grows. Additionally, another process can monitor log files in storage and truncate them as needed to maintain an amount storage space consumed by the log files.

### BACKGROUND

The disclosure generally relates to the field of data processing, and more particularly to network data collection.

For management of devices in a network, a system manager collects data from the devices. Data collection can be done according to the well-defined Simple Network Management Protocol (SNMP). The system manager or network manager can send GET requests to SNMP-enabled devices with specified object identifiers (OIDs) to collect a device definition, a device attribute, a 2 dimensional array of managed objects, etc. SNMP-enabled devices provide responses with the values corresponding to the requested OIDs. This request-response exchange may be referred to as SNMP data collection. Similar data collection operations may be performed for non-SNMP devices using device specific protocols or application programming interfaces. The collected data may be stored in logs which can be used for network performance monitoring or root cause analysis.

### BRIEF DESCRIPTION OF THE DRAWINGS

Aspects of the disclosure may be better understood by referencing the accompanying drawings.

FIG. 1 depicts an example illustration of a data collection and logging system with data collectors and scalable log monitors that persist collected log data in storage.

FIG. 2 depicts an example system for assignment of logs to instantiated log monitors.

FIG. 3 is a flowchart of example operations for managing log monitors.

FIG. 4 is a flowchart of example operations for offloading logs in memory to a storage device.

FIG. 5 is a flowchart of example operations for monitoring log files in persistent storage.

FIG. 6 depicts an example computer system with a scalable data logging application.

### DESCRIPTION

The description that follows includes example systems, methods, techniques, and program flows that embody aspects of the disclosure. However, it is understood that this disclosure may be practiced without these specific details. For instance, this disclosure refers to offloading data collected from devices in a network in illustrative examples. Aspects of this disclosure can be also applied to data storage systems which buffer data in memory prior to transferring the data to persistent storage. In other instances, well-known instruction instances, protocols, structures, and techniques have not been shown in detail in order not to obfuscate the description.

### Introduction

In a high scale network environment, a network may include thousands of devices. Collecting network management data from these devices can tax the resources of data collection systems. For example, if a network includes 5,000 devices, collecting and storing a 2 megabyte log for each device requires 10 gigabytes of memory just for the logs alone. Insufficient memory can cause data loss as log data is overwritten and can cause poor performance or failure of data collection systems. While some data collection systems may dump log data from memory into a log file, the aggregation of log data from thousands of devices into a few log files can create issues with file operations and data management/analysis.

### Overview

A scalable data collection and logging system can collect and persist data from a high scale network environment with less strain on memory resources. The system includes data collectors which collect data from network devices and store the data in device-specific logs in memory. The system also includes log monitors which periodically offload and compress the logs in memory and append the logs to device specific log files in storage, thereby freeing up memory space and persisting the log data for future analysis. A log monitor manager load balances offloading operations across available log monitors and can instantiate additional log monitors to scale the offloading operations as a network grows. Additionally, another process can monitor log files in storage and truncate them as needed to maintain an amount storage space consumed by the log files.

### Example Illustrations

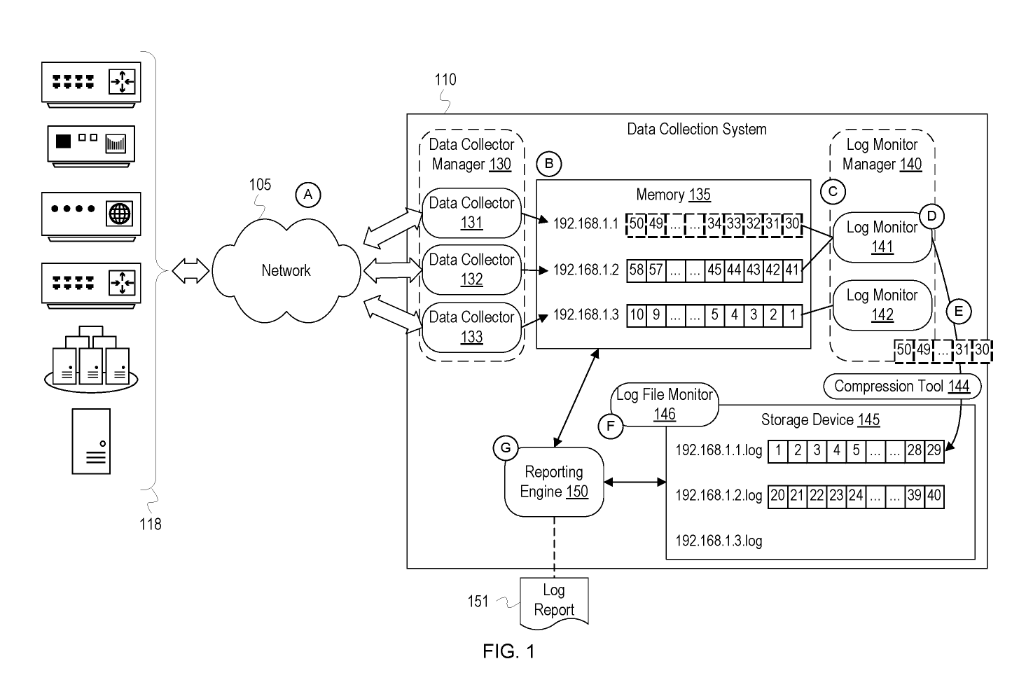

FIG. 1 depicts an example illustration of a data collection and logging system with data collectors and scalable log monitors that persist collected log data in storage. FIG. 1 depicts a data collection and logging system 110 which includes a data collector manager 130, a log monitor manager 140, a log file monitor 146, and a reporting engine 150. The data collection and logging system 110 utilizes a memory 135 and a storage device 145. The storage device 145 may be a hard disk, flash storage, storage cluster, cloud storage, etc. The data collector manager 130 manages a data collector 131, a data collector 132, and a data collector 133 which collect data through a network 105 from networked devices 118. The network devices 118 include devices such as servers, routers, switches, etc., which may be a combination of SNMP-compliant devices, non-SNMP compliant devices, etc. The data collectors 131, 132, and 133 are agents, daemons, or services instantiated by the data collector manager 130 that run on nodes of the data collection and logging system 110 (e.g., computing devices that may be considered servers). Similarly, log monitor 141 and log monitor 142 are agents, daemons, or services instantiated by the log monitor manager 140 that run on nodes of the data collection and logging system 110 and monitor logs of collected data in the memory 135.

At stage A, the data collectors 131, 132, and 133 (“data collectors”) collect data from the network devices 118 through the network 105. The data collectors may communicate with the network devices 118 through a physical or wireless connection to the network 105, which may be a local area network, a wide area network, or a combination of the foregoing. The data collectors may communicate with the network devices 118 by way of communication protocols (e.g., Transmission Control Protocol/Internet Protocol (TCP/IP), User Datagram Protocol (UDP), file transfer protocol (FTP)) to collect data related to operating conditions, performance metrics, etc., of the network devices 118. This data collection can be done periodically according to the Simple Network Management Protocol (SNMP), device specific plug-ins/scripts, application program interfaces (APIs), etc. The collected data may be used to determine metrics such as device or network health and performance (e.g., availability, throughput, bandwidth utilization, latency, error rates, and processor utilization). The data collectors may also process the collected data by converting a file format containing the collected data or by normalizing the data and/or data structure to conform to the current network management system and/or ease of processing or uniformity. For example, collected data may be in a variety of formats (e.g., XML, CSV, JavaScript Object Notation (JSON), etc.), different data structures (e.g., array, record, graph, etc.) and/or different numeric systems (e.g., Metric, English) and is converted from one numeric system to another.

In FIG. 1, each of the data collectors is depicted as collecting data for a single Internet Protocol (IP) address assigned to a device in the network devices 118. The data collector 131 collects data for a device corresponding to the IP address 192.168.1.1, the data collector 132 collects for 192.168.1.2, and the data collector 133 collects for 192.168.1.3. In some implementations, each data collector may collect data for hundreds or thousands of devices. The data collector manager 130 assigns devices from the network devices 118 to the data collectors and load balances the data collection assignments across the available data collectors. The data collector manager 130 can instantiate additional data collectors as devices are added to the network devices 118 or as additional resources for data collection become available. For example, if another compute node is made available to the data collection and logging system 110, the data collector manager 130 may instantiate another data collector to execute on the node and redistribute collection assignments across the data collectors.

At stage B, the data collectors write the collected data to logs in the memory 135. The data collector manager 130 may allocate memory for a data collector when the data collector is instantiated, or a data collector may be programmed to allocate memory for a log for each device from which data is collected. A log is a collection of log entries and may be a data structure such as an array, linked list, circular buffer, etc. Each entry in a log may be a data object or a text that includes the collected data, calculated metrics, etc. Each entry may be separated by a new line character, comma, semicolon, etc. In FIG. 1, the log entries are numbered for ease of explanation and do not depict typical log entry data. A data collector writes a new entry to the corresponding log each time data is collected from the device corresponding to the IP address or log. For example, in FIG. 1, the data collector 131 has written a total of fifty entries to the log for the IP address 192.168.1.1 indicating that data has been collected fifty times from the corresponding network device. The data collector 132 has written a total of fifty-eight entries, and the data collector 133 has written ten entries. The data collectors may collect data at different rates, collect data from specified network devices more frequently, or may be configured to only log collected data when certain conditions are met. For example, a data collector may only log collected data if a specified metric has changed in value since the previously collected metric value. As a result, the size and growth rate of the logs may differ.

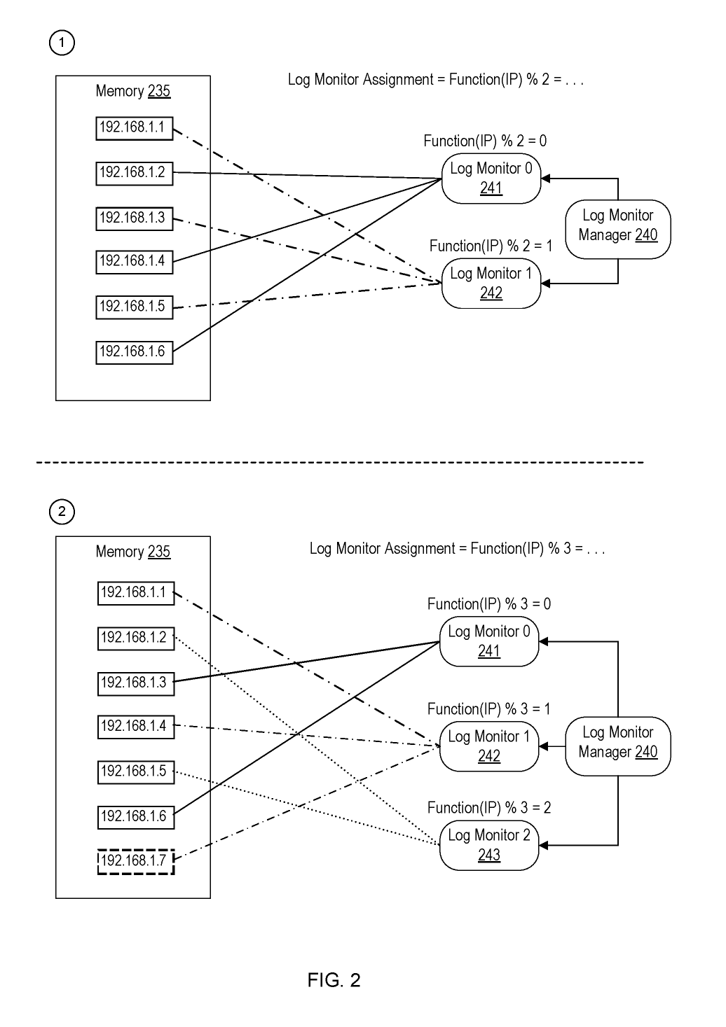

At stage C, the log monitor manager 140 instantiates the log monitor 141 and the log monitor 142 to monitor logs in the memory 135. As additional device logs are created in the memory 135, the log monitor manager 140 instantiates log monitors to be responsible for offloading log entries from the memory 135 to log files in the storage device 145. In FIG. 1, the log monitor manager 140 has instantiated the log monitor 141 to monitor the logs for the IP addresses 192.168.1.1 and 192.168.1.2 and has instantiated the log monitor 142 to monitor the log for the IP address 192.168.1.3. The log monitor manager 140 assigns and load balances the logs across available log monitors. In the example of FIG. 1, if an additional log is created in the memory 135, the log monitor manager 140 will assign the new log to the log monitor 142 as the log monitor 142 is currently assigned a single log, whereas the log monitor 141 is assigned two logs. The log monitor manager 140 may use different heuristics for load balancing assignments across available log monitors and for determining whether to instantiate additional log monitors. The log monitor manager 140 may use a formula that determines log assignments based on IP addresses, as described in more detail in FIG. 2. The log manager 140 may monitor a number of logs assigned to each log monitor and assign new logs to the log monitor with a least number of assigned logs. Additionally, if the number of logs assigned to each log monitor exceeds a threshold, the log monitor manager 140 may determine that an additional log monitor should be instantiated. The number of log monitors instantiated by the log monitor manager 140 can vary based on a total number of logs in the memory 135, available resources such as memory and processing power, and desired performance. Some systems may have a limit on a number of simultaneous file access operations. For example, some operating systems may limit simultaneous file access operations to one thousand simultaneous operations. Since the log monitors access files to offload log data, the upper bound on a total number of log monitors is equal to the simultaneous file access limit.

At stage D, the log monitor 141 selects the log for the IP address 192.168.1.1 for offloading to the storage device 145. The log monitor 141 iterates through its assigned logs and periodically offloads each log to a corresponding log file on the storage device 145 to prevent an excess amount of log data from accumulating in the memory 135. For example, the log monitor 141 may offload the log for 192.168.1.2 and then ten seconds later begin offloading the log for 192.168.1.1. In an alternative example, the log monitor 141 may alternate offloading log entries for 192.168.1.1 and 192.168.1.2 with no time in between. In some implementations, the log monitor 141 monitors sizes of its assigned logs and offloads a log when the log size satisfies a threshold. For example, each log may have a limit of 2 megabytes, so the log monitor 141 offloads a log when the log is close to or at the 2 megabyte limit. The amount of memory allocated for a log can be configured or can be dynamic based on an amount of available memory or a total number of logs. The log monitor 141 offloads the entries in the log 192.168.1.1 by reading the entries 30-50 from the memory 135 and then clearing or freeing up the space occupied by the logs in the memory 135. The log monitor 141 may also adjust metadata or header information for the log. For example, the log monitor 141 may update header information that indicates a number of entries in the log to 0. In some implementations, the log monitor 141 may not offload all available entries. For example, the log monitor 141 may be configure to offload 20 entries at a time and to not offload any entries from a log unless there are at least 20 entries available to be offloaded.

At stage E, the log monitor 141 compresses and appends the offloaded log entries for the IP address 192.168.1.1 to a log file on the storage device 145. The log monitor 141 invokes the compression tool 144 to compress the offloaded entries. The compression tool 144 can use a variety of compression techniques such as gzip, Roshal Archive (RAR), zip, etc. After the log entries are compressed, the log monitor 141 identifies and accesses the log file for 192.168.1.1. In instances where a log file is not already created, the log monitor 141 creates a log file for the IP address. The log monitor 141 then appends the compressed log entries to the existing data in the log file. Each log file comprises chunks of compressed data which include the offloaded log entries. The log monitor 141 may also modify header or metadata information for the log file to indicate a number of compressed chunks, indicate a number of entries in the compressed data, update a total number of log entries in the log file, etc.

At stage F, the log file monitor 146 maintains the logs in the storage device 145. The log file monitor 146 is configured to track sizes of the logs in the storage device 145 and keep each log below a threshold size. For example, the log file monitor 146 may ensure that each log is no larger than 100 megabytes. If a log reaches or exceeds a threshold size, the log file monitor 146 truncates the log by removing old log entries so that the log is again below the threshold size. Because the log files comprise multiple compressed chunks of data, the log file monitor 146 reads the file into memory, such as the memory 135, and decompresses each of the chunks. The log file monitor 146 then estimates a size reduction of the decompressed log file that will place the log file in compliance with the size threshold after being recompressed. For example, a compressed log file may be 7 megabytes which exceeds a size threshold of 5 megabytes. After the log file monitor 146 decompresses the log file, the log file may be 14 megabytes in size. The log file monitor 146 can then estimate that removing 6 megabytes from the decompressed log file will result in an approximately 4 megabyte log file after recompression, thereby satisfying the threshold. The storage monitor's 146 estimate is adjusted based on a size of the compressed log file, a size of the decompressed log file, the compression technique utilized, a compression ratio, etc. For example, compression techniques are generally less effective on small file sizes, so the log file monitor 146 may remove more decompressed data from a smaller log file than is removed from a larger file. Additionally, less data will removed from log files for which a more efficient compression technique is used.

In addition to removing enough data to satisfy a size threshold, the log file monitor 146 removes enough data to leave a buffer for additional entries to be added to the log. For example, if a threshold size for a log file is 100 megabytes and a log file is 110 megabytes, the log file monitor 146 may remove enough log entries to reduce the log size to 80 megabytes, which places the log below the threshold and leaves 20 megabytes of buffer for new entries. The log file monitor 146 may adjust a size of the buffer based on available system resources, how quickly log entries are being offloaded to the storage device 145, etc. For example, if the log file monitor 146 has truncated a log a threshold number of times within a time period, the log file monitor 146 may increase the buffer size in order to decrease the frequency with which the log is truncated.

To avoid leaving partial log entries in a log file, the log file monitor 146 performs calculations to determine a number of complete log entries to remove from a log file based on an overall size reduction determined above. For example, given a decompressed log file of 2.1 megabytes which exceeds a 2 megabyte threshold, the log file monitor 146 determines that 0.3 megabytes of data should be removed to achieve a target log file size of 1.8 megabytes, leaving a 10% buffer. The log file monitor 146 calculates a percentage reduction in the overall file size to achieve the target size. To continue the example, the log file monitor 146 calculates that 1−(Target Size(1.8)/Current Size(2.1))=1−˜0.85=0.15, or a 15% reduction in size. The log file monitor 146 then multiplies a total number of log entries in the log file by the reduction ratio to determine a number of log entries to remove. For example, if the 2.1 megabyte log file has 210,000 log entries, the log file monitor 146 calculates 210,000*0.15 to determine that 31,500 log entries should be removed from the log file to achieve the 1.8 megabyte target size. The log file monitor 146 removes the determined number of oldest log entries from the log file, recompresses the log file, and again stores the log file on the storage device 145.

At stage G, the reporting engine 150 generates the log report 151. The reporting engine 150 allows for data collected from the network devices 118 and stored in the log files to be viewed and analyzed. The reporting engine 150 can filter the logged data by IP address and IP domain, display a list of polled devices, allow for text searching of the logged data, etc. For example, in response to receiving the IP address 192.168.1.2, the reporting engine 150 searches the storage device 145 to identify the log file for the indicated IP address. The reporting engine 150 then reads and decompresses the log file and adds entries 20-40 to the log report 151. The reporting engine 150 also searches for and retrieve a log corresponding to the IP address 192.168.1.2 from the memory 135. The reporting engine 150 appends the log entries from the memory 135 to the entries retrieved from the storage device 145 resulting in entries 20-58 in the log report 151. Based on indicated parameters, the reporting engine 150 may further process or filter the log entries in the log report 151. For example, the reporting engine 150 may only include entries that indicate an SNMP polling error.

In some implementations, the log file monitor 146 may not decompress log files prior to truncation as described above at stage F. Instead, the log file monitor 146 may simply remove older compressed chunks of offloaded entries from the log file. For example, if a log file comprises 6 compressed chunks of log entries, the log file monitor 146 may remove the 2 oldest compressed chunks from the log file to place the log file in compliance with a size threshold.

FIG. 1 is annotated with a series of letters A-G. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

FIG. 2 depicts an example system for assignment of logs to instantiated log monitors. FIG. 2 depicts a memory 235 and a log monitor manager 240 that manages a log monitor 0 241, a log monitor 1 242, and a log monitor 2 243. The memory 235 includes logs for 6 IP addresses associated with devices in a network. The logs include data collected from the devices.

FIG. 2 depicts the example system at two different points in time: a time 1 and a time 2. At time 1, the log monitor manager 240 has instantiated the log monitor 0 241 and the log monitor 1 242 to monitor the 6 logs in the memory 235. The log monitor manager 240 uses the depicted formula (Function(IP) % 2) to assign and load balance the logs across the two log monitors. The formula uses the IP address of a log as an argument to a function and takes the modulus 2 of the result of the function to determine which of the two log monitors will be assigned the log. The function may process the IP address in a number of ways. For example, the function may hash the IP address using hash techniques such as the Secure Hash Algorithm or MD5. In FIG. 2, the function converts the IP address into a number so that a modulus 2 of the IP address may be determined. For example, the IP address 192.168.1.1 becomes the number 19,216,811. The modulus 2 of 19,216,811 is 1 which means that the log for the IP address 192.168.1.1 is assign to the log monitor 1 242. The log monitor manager 240 continues applying the formula to the rest of the logs to determine assignments. For example, the IP address 192.168.1.2 becomes the number 19,216,812 which has a modulus 2 of 0, so the log for the IP address 192.168.1.2 is assigned to the log monitor 0 241. The function may also perform other manipulations to the IP address, such as applying mathematical operations, rounding the IP address, truncating the IP address, etc.

At time 2 (depicted below the dashed line), a log for the IP address 192.168.1.7 has been added to the memory 235. A data collector may have created the log in response to a new device being added to the network. The log monitor manager 240 detects the addition of the new log and determines that an additional log monitor should be instantiated. The determination to instantiate an additional log monitor may be based on various criteria. For example, the log monitor manager 240 may be configured to assign no more than 3 logs to each log monitor. As an additional example, the log monitor manager 240 may be programmed to maintain performance criteria such as x number of log offloads per second and determine that an additional log monitor is needed to satisfy the performance criteria. Based on determining that an additional log monitor is needed, the log monitor manager 240 instantiates the log monitor 2 243 in addition to the log monitor 0 241 and the log monitor 1 242. The log monitor manager 140 then redistributes the log assignments over the log monitors. Since there are now three log monitors, the formula is updated to take a modulus 3 of the Function(IP) result so that three outcomes are possible: 0, 1, and 2. The logs are then assigned to the log monitors based on the updated formula.

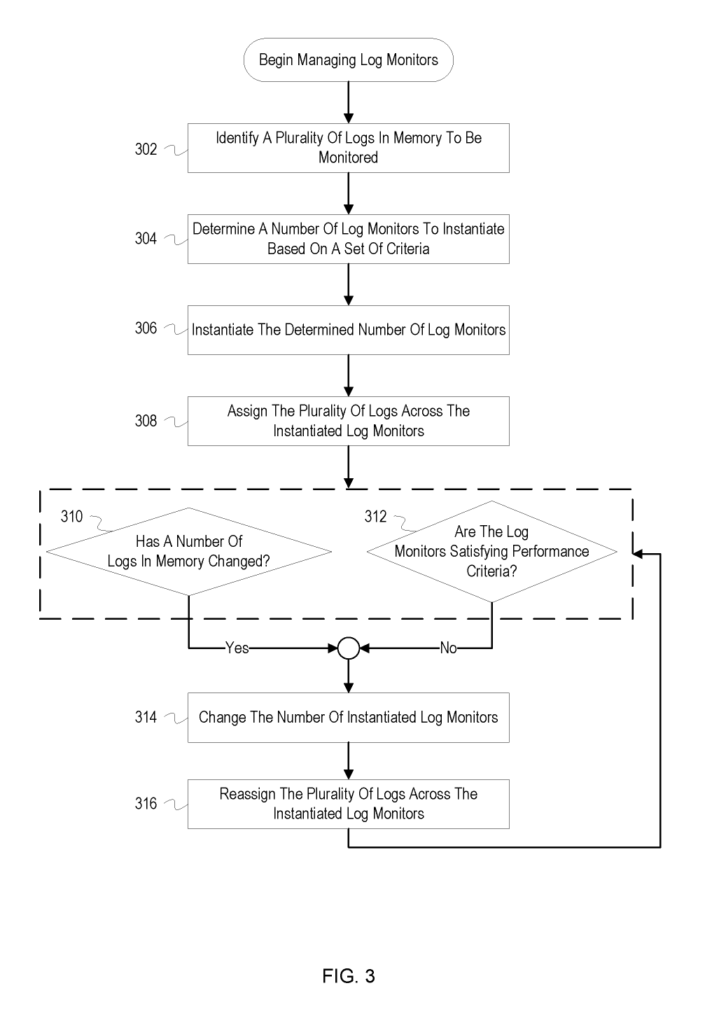

FIG. 3 is a flowchart of example operations for managing log monitors. The description in FIG. 3 refers to a log monitor manager performing the example operations for naming consistency with FIG. 1, although naming of program code can vary among implementations.

A log monitor manager (“manager”) identifies a plurality of logs in memory to be monitored (302). The manager may periodically scan the memory to identify header information or metadata that indicates the beginning of a log. In some implementations, a data collector manager, such as the data collector manager 130 described in FIG. 1, and any corresponding data collectors may maintain a table in memory that indicates the memory address spaces that have been allocated for logs. When memory space is allocated for a new log, the data collector manager or the responsible data collector updates the shared table with an additional entry and may notify the log monitor manager of the update. Alternatively, the manager may periodically scan the table for current logs and changes to the shared table. The manager also retrieves an identifier for each of the plurality of logs. The identifier may be an IP address associated with data indicated in the log or may be an identifier assigned by a data collector.

The manager determines a number of log monitors to instantiate based on a set of criteria (304). The set of criteria may include configured log assignment thresholds, desired performance metrics, available resources, etc. For example, if the manager is configured to assign no more than 5 logs to each log monitor, the manager divides the number of logs in the plurality of logs by 5 to determine the number of log monitors to instantiate. For performance metrics, the manager may be configured to instantiate enough log monitors to provide a throughput of x number of logs offloaded per second. The manager can determine how many log monitors are needed by measuring a time required for a log monitor to offload a log to storage. For example, if the desired throughput is 1 log offloaded per second and a log monitor requires 2 seconds to offload a log, the manager needs at least two log monitors to be offloading logs so that the desired throughput can be achieved. In some instances, the manager may be constrained by available resources, such as processing power, memory, available processor time, processor threads, etc. In these instances, the manager may determine to instantiate as many log monitors as allowed by the available resources and may attempt to dynamically balance resources as needed. For example, if a system executing the log monitors requests additional memory, the manager may instantiate additional log monitors to offload log entries more quickly, thereby freeing up additional memory. Alternatively, if the system requests additional processor resources, the manager may reduce a number of instantiated log monitors, thereby freeing up processor resources. The manager may subscribe to an performance monitor of the system executing the log monitors to receive metrics and alerts related to available resources.

The manager instantiates the determined number of log monitors (306). A log monitor is a macro, script, container, application, or other software process that can be invoked or triggered by the manager. For example, if a log monitor is a process that runs within a container, the manager duplicates and begins running containers equal to the determined number of log monitors. As an additional example, if the log monitor is a script, the manager begins executing multiple instantiations of the script and may assign each script its own processor core or processor thread.

The manager assigns the plurality of logs to be monitored across the instantiated log monitors (308). The manager may configure each log monitor during instantiation to monitor specified logs or may maintain a table of log assignments which is shared with the log monitors who then determine their assignments from the table. The manager may use various techniques to assign the logs. The manager may manually distribute logs across the log monitors or may use a formula to determine log assignments as described in FIG. 2. In some implementations, the manager may analyze data collection rates for each of the logs and use the rates to load balance log assignments across the log monitors. The data collectors may be configured to collect data from network devices at different rates. For example, a data collector may collect data from a first device once per minute and collect data from a second device four times per minute. As a result, the log for the second device will populate more quickly and require a log monitor to more frequently offload the log to storage. The manager retrieves the data collection rates from the data collector manager and then determines a distribution of the logs that effectively load balances offloading operations across the log monitors. To continue the example above, a first log monitor may be solely assigned the log for the second device which collects data 4 times per minute while a second log monitor may be assigned the log for the first device which collects data 1 time per minute as well as other logs with low data collection rates. In some instances, if a log has a high data collection rate, the manager may assign two or more log monitors to handle offloading operations for the single log.

After assigning the plurality of logs to the instantiated log monitors, the manager begins operations for managing operation and performance of the log monitors (310 and 312). These operations, depicted inside the dashed line box of FIG. 3, occur in parallel and continue throughout management of the log monitors. The manager monitors a number of the plurality of logs in memory and determines whether the number of logs in memory has changed (310). The manager may monitor the logs in memory or monitor indications of logs in a table maintained by a data collector manager.

Additionally, the manager determines whether the log monitors are satisfying performance criteria (312). As described above, the manager may be configured to maintain various performance criteria, such as a threshold throughput of logs offloaded per minute. If the log monitors are not achieving the threshold throughput, the manager determines that the performance criteria is not being satisfied. As an additional example, the manager may be configured to ensure that that logs in memory do not exceed a specified size (e.g., 2 megabytes). The manager monitors the sizes of the plurality of logs to determine whether this performance criteria is being satisfied. If logs are frequently nearing or encroaching on the threshold size, the manager determines that the performance criteria is not being satisfied.

If the number of logs has changed (310) or if the log monitors are not satisfying performance criteria (312), the manager changes the number of instantiated log monitors (314). If the number of logs increases, the manager determines that there is an unassigned log. The manager then determines whether there is an available log monitor which can handle the additional load of the unassigned log. If there is not an available log monitor to handle the unassigned log, the manager instantiates an additional log monitor. If the number of logs decreases, the manager determines whether the number of log monitors can be reduced and removes any excess log monitors. In instances where performance criteria is not being satisfied, the manager instantiates additional log monitors. The number of additional log monitors instantiated can change based on a degree to which the performance criteria was not being satisfied. For example, if the log monitors are operating at 10% below performance requirements, the manager may only instantiate one additional log monitor; whereas, if the log monitors are underperforming by 50%, the log manager may instantiate 5 additional log monitors. In some instances, the manager may also receive new or different performance criteria which triggers the instantiation of additional log monitors or a decrease in the number of log monitors. For example, a new performance criteria may require the manager to utilize fewer resources and, therefore, decrease the number of log monitors.

The manager reassigns the plurality of logs across the instantiated log monitors (316). The manager assigns logs in a manner similar to that described at block 308. If an additional log monitor was instantiated for an unassigned log, the manager may simply assign the unassigned log to the new log monitor without changing the existing log assignments. After reassignment of the logs, the manager continues operations for managing operation and performance of the log monitors (310 and 312).

The operations of blocks 314 and 316 may be iterative. For example, the manager may instantiate an additional log monitor, reassign the plurality of logs, and evaluate the performance of the log monitors with the additional log monitor. If the performance is still insufficient, the manager may instantiate a second additional log monitor, reassign the plurality of logs, evaluate the performance of the log monitors with the second additional log monitor, and so on.

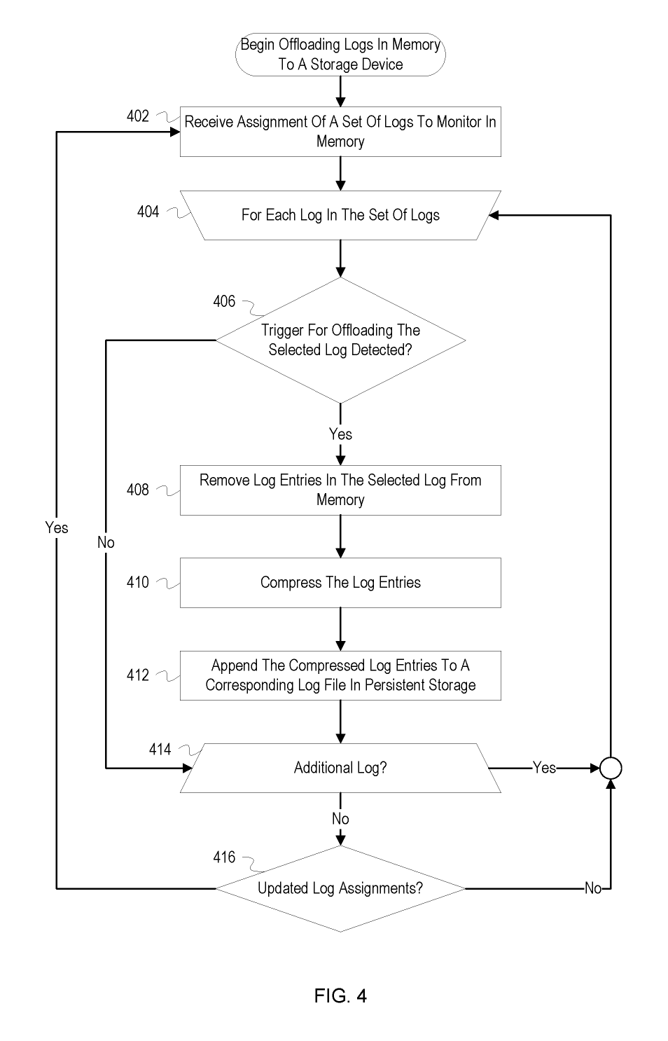

FIG. 4 is a flowchart of example operations for offloading logs in memory to a storage device. The description in FIG. 4 refers to a log monitor performing the example operations for naming consistency with FIG. 1, although naming of program code can vary among implementations.

A log monitor receives assignment of a set of logs to monitor in memory (402). The log monitor may receive the assignment from a log monitor manager or other process that assigns logs stored in memory of a data collection system. The log monitor may receive identifiers for each of the logs and may search the memory to determine a location of each of the logs. Alternatively, the log monitor may receive a memory address or a pointer to a head of each of the logs. In some implementations, the log monitor may check a table in memory or other storage that indicates log assignments and retrieve its assignments from the table.

The log monitor begins offloading operations for each log in the set of logs (404). The log for which operations are currently being performed is hereinafter referred to as “the selected log.”

The log monitor determines whether a trigger for offloading the selected log has been detected (406). The log monitor may offload the selected log periodically, when the log has reached a specified size, or as requested by another service such as a reporting engine. For example, the log monitor may be programmed to offload each log every 2 minutes. If two minutes have passed since offloading the selected log, the log monitor determines that the selected log should again be offloaded. As an additional example, the log monitor may periodically check a size of the selected log. If the size of the selected log exceeds a specified threshold, the log monitor determines that the selected log should be offloaded.

If a trigger for offloading the selected log has been detected, the log monitor removes entries in the selected log from memory (408). The log monitor reads some or all of the log entries from memory and then clears the space occupied by the logs. The log monitor may be programmed to offload a specified number of log entries at a time. In such instances, the log monitor offloads the specified number of the oldest log entries from the log. The log monitor may clear the memory space occupied by the logs by changing header or metadata information which indicates a number of entries in the log, by resetting a pointer of a linked list or buffer to the first entry, etc.

The log monitor compresses the removed log entries (410). The log monitor uses compression techniques such as gzip, Roshal Archive (RAR), zip, etc., to compress the removed log entries.

The log monitor appends the compressed log entries to a corresponding log file in persistent storage (412). The log monitor may use an identifier for the log to locate a log file in the storage. If a log file does not exist, the log monitor creates a new log file and names or associates the log file with the identifier for the log. The log monitor accesses the log file and writes the compressed log entries to the end of the log file. The log monitor may also update metadata associated with the log file that indicates a total number of compressed log entry chunks, a number of entries included in each chunk, a total number of log entries, etc.

If a trigger for offloading the selected log has not been detected (406) or after appending the compressed log entries to a log file (412), the log monitor determines whether there is an additional log in the set of logs (414). If there is an additional log, the log monitor selects the next log in the set of logs.

If there is not an additional log, the log monitor determines whether updated log assignments have been issued (416). The log monitor may check if new or additional log assignments have been received from a log monitor manager or determine whether log assignments indicated in a table have changed. The table of log assignments may include a flag at a specified memory location that is set if log assignments have changed. The log monitor may monitor the flag and retrieve updated assignments when the flag has been set. If updated assignments have been issued, the log monitor receives the updated assignment of a set of logs to monitor in memory (402) and begins monitoring operations for the newly assigned logs (404). If updated assignments have not been issued, the log monitor continues offloading operations for the currently assigned set of logs (404).

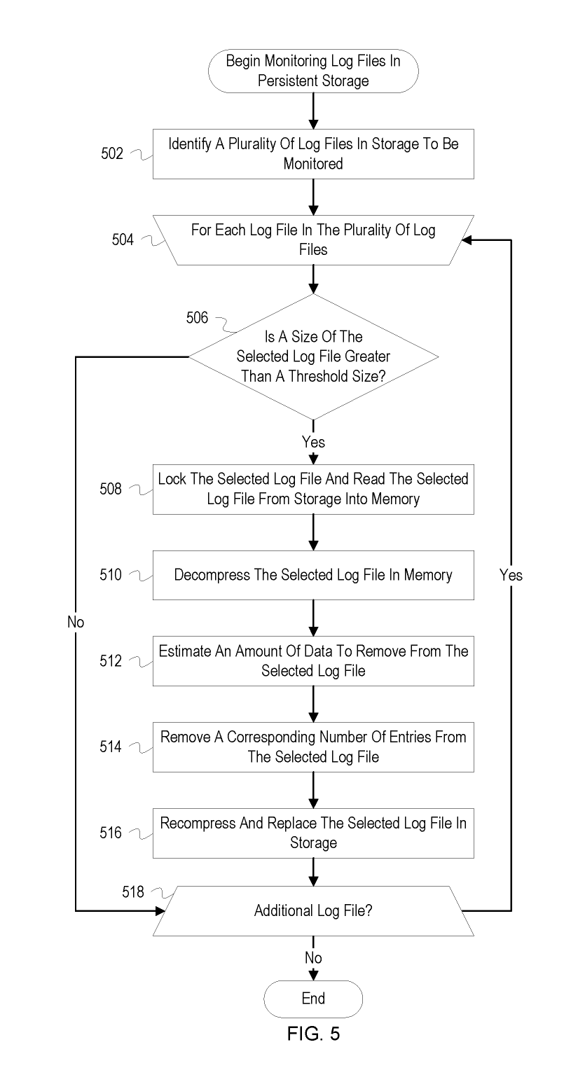

FIG. 5 is a flowchart of example operations for monitoring log files in persistent storage. The description in FIG. 5 refers to a log file monitor performing the example operations for naming consistency with FIG. 1, although naming of program code can vary among implementations.

A log file monitor identifies a plurality of log files in storage to be monitored (502). The log file monitor may be assigned or detect a volume or other storage location that includes the log files to which log data is being offload by a plurality of log monitors. The log file monitor may analyze the plurality of log files to collect metadata for monitoring purposes, determine storage addresses, etc.

The log file monitor begins monitoring operations for each log file in the plurality of log files (504). The log file for which operations are currently being performed is hereinafter referred to as “the selected log file.”

The log file monitor determines whether a size of the selected log file is greater than a threshold size (506). The threshold size is the maximum amount of storage space for a log file. The log file monitor may identify the threshold size in configuration information or may determine the threshold size based on a number of log files and an amount of storage space. For example, if there are 10 log files and 25 gigabytes of storage space, the log file monitor may determine that the threshold size for each log file is 2.5 gigabytes, or the log monitor may determine that the threshold size is 2 gigabytes and leave 5 gigabytes of storage space as a buffer. The log file monitor may determine the size of the selected log file from metadata information or from file system data and compare the size of the selected log file to the threshold size.

If the log file monitor determines that the size of the selected log file is greater than the threshold size, the log file monitor locks the selected log file and reads the selected log file from storage into memory (508). The log file monitor locks the selected log file to prevent additional log entries or data being written to the log file by a log monitor while the log file monitor is accessing the log file. The log file monitor may lock the selected log file by changing the permissions to read only.

The log file monitor decompresses the selected log file (510). The selected log file comprises a number of compressed chunks of log entries. The log file monitor identifies a compression technique used to compress the chunks and then decompresses each of the chunks using the identified compression technique.

The log file monitor estimates an amount of data to remove from the selected log file (512). Since the selected log file will be recompressed prior to storage, the log file monitor is unable to determine an exact amount of size reduction for the decompressed selected log file which will result in the selected log file being less than the threshold size once recompressed. As a result, the log file monitor makes an estimate based on a set of criteria. The criteria can include a size of the compressed log file, a size of the decompressed log file, the compression technique utilized, an amount with which the size of the selected log file exceeds the threshold, etc. In some instances, the log file monitor may use a formula based on a typical compression ratio for each compression technique. For example, if a first compression technique has a typical compression ratio of 2:1 (i.e. 2 bytes of data compress to 1 byte of data), the log file monitor may use a formula that doubles the amount of compressed data to remove and removes the doubled amount from the decompressed data, e.g. if the compressed log file exceeds the threshold by 1 megabyte, the log file monitor doubles that amount and therefore removes 2 megabytes from the decompressed log file.

The log file monitor removes a number of entries from the selected log file equal to the amount of data to remove (514). The log file monitor identifies a number of the oldest entries in the selected log file that collectively equal or approximately equal the amount of data to be removed. The log file monitor deletes the entries from the selected log file and updates any header information or metadata accordingly.

The log file monitor recompresses and replaces the selected log file in storage (516). The log file monitor recompresses the selected log file which has had the number of entries removed. The log file monitor may then delete the old version of the selected log file from storage or overwrite the old version of the selected log file in storage with the new, smaller version of the selected log file. In some implementations, the log file monitor may ensure that the new selected log file is below the threshold size after recompression, and if the log file is not below the threshold, the log file monitor may decompress and remove additional entries from the selected log file prior to storage.

After recompressing and replacing the selected log file in storage (516) or if the log file monitor determines that the size of the selected log file is not greater than the threshold size (508), the log file monitor determines whether there is an additional log file (518). If there is an additional log file, the log file monitor selects the next log file (504). If there is not an additional log file, the process ends.

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 306 and 308 of FIG. 3 can be performed in parallel or concurrently. Additionally, the operation depicted in block 416 of FIG. 4 may not be performed. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

Some operations above iterate through sets of items, such as logs in memory or log files (“logs”). In some implementations, logs may be iterated over according to an ordering of logs, an indication of log importance, a timestamp associated with each log, a device type associated with each log, a size of each log, etc. Also, the number of iterations for loop operations may vary. Different techniques for processing logs may require fewer iterations or more iterations. For example, multiple logs may be offloaded from memory in parallel. Similarly, multiple log files may be truncated to comply with storage thresholds in parallel.

The examples often refer to a data collection manager and a log monitor manager. The term manager is a construct used to refer to implementation of functionality for instantiating, controlling, and monitoring a collection of agents or software processes. This construct is utilized since numerous implementations are possible. A manager may be a hypervisor with additional program code, an application, a particular component or components of a machine (e.g., a particular circuit card enclosed in a housing with other circuit cards/boards), machine-executable program or programs, firmware, a circuit card with circuitry configured and programmed with firmware for instantiation monitor and collector software, etc. The term is used to efficiently explain content of the disclosure. Although the examples refer to operations being performed by managers, different entities can perform different operations. For instance, a dedicated co-processor or application specific integrated circuit can instantiate, control, and monitor a collection of agents or software processes.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

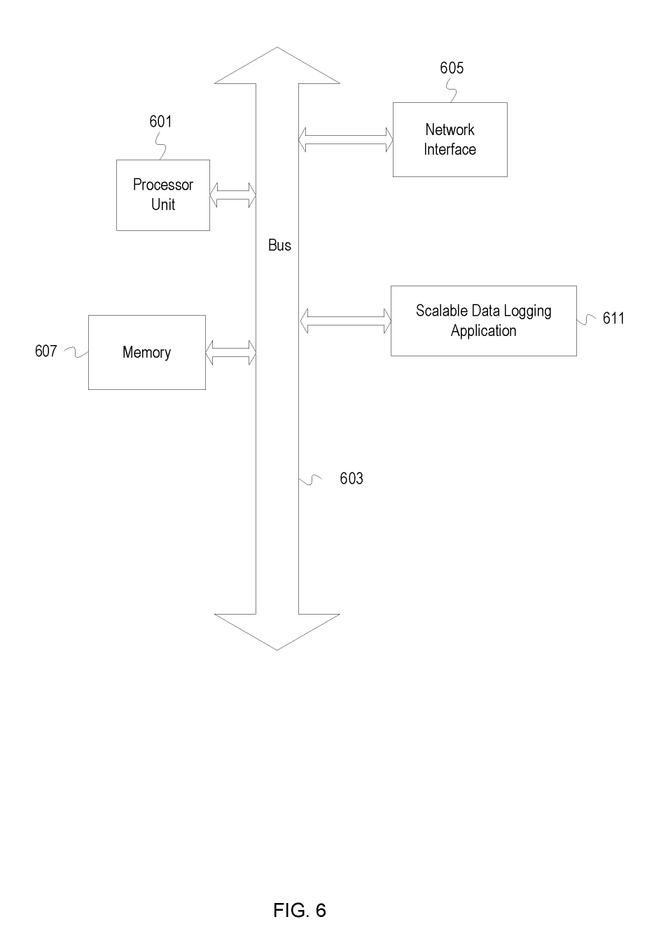

FIG. 6 depicts an example computer system with a scalable data logging application. The computer system includes a processor unit 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 603 (e.g., PCI, ISA, PCI-Express, HyperTransport® bus, InfiniBand® bus, NuBus, etc.) and a network interface 605 (e.g., a Fiber Channel interface, an Ethernet interface, an internet small computer system interface, SONET interface, wireless interface, etc.). The system also includes a scalable data logging application 611. The scalable data logging application 611 scales operations for offloading logs from memory to storage based on a number of logs and performance criteria. Any one of the previously described functionalities may be partially (or entirely) implemented in hardware and/or on the processor unit 601. For example, the functionality may be implemented with an application specific integrated circuit, in logic implemented in the processor unit 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601 and the network interface 605 are coupled to the bus 603. Although illustrated as being coupled to the bus 603, the memory 607 may be coupled to the processor unit 601.

While the aspects of the disclosure are described with reference to various implementations and exploitations, it will be understood that these aspects are illustrative and that the scope of the claims is not limited to them. In general, techniques for scalable log offloading operations as described herein may be implemented with facilities consistent with any hardware system or hardware systems. The variations described above do not encompass all possible variations, implementations, or embodiments of the present disclosure. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
detecting a plurality of logs in memory of a first system, wherein each log of the plurality of logs comprises data collected from a network device;
instantiating a first monitor and a second monitor;
distributing assignments for offloading the plurality of logs from the memory to a storage device across the first monitor and the second monitor; and
based on determining that the first monitor and the second monitor do not satisfy performance criteria,
instantiating a third monitor; and
redistributing assignments for offloading the plurality of logs across the first monitor, the second monitor, and the third monitor.

2. The method of claim 1 further comprising:
offloading, by the first monitor, a first log of the plurality of logs from the memory of the first system to the storage device, wherein offloading the first log comprises,
detecting a trigger for offloading the first log; and
based on detecting the trigger,
removing the first log from the memory;
compressing the first log; and
appending the compressed first log to a log file corresponding to the first log in the storage device.

3. The method of claim 2, wherein detecting the trigger for offloading the first log comprises at least one of:
determining that the first log has exceeded a threshold size;
receiving a request to offload the first log;
completing offloading of a second log of the plurality of logs; and
determining that a period of time has elapsed since the first log was previously offloaded.

4. The method of claim 1, wherein determining that the first monitor and the second monitor satisfy the performance criteria comprises at least one of:
determining that the first monitor and the second monitor are consuming more than an allotted amount of resources on the first system;
determining that the first monitor and the second monitor are not offloading a threshold number of logs within a time period; and
determining that the first monitor and the second monitor are not maintaining each of the plurality of logs below a threshold size.

5. The method of claim 1, wherein distributing the assignments for offloading the plurality of logs across the first monitor and the second monitor comprises:
for each of plurality of logs,
determining an identifier for the log; and
determining whether to assign the log to the first monitor or the second monitor based, at least in part, on evaluating a function that uses the identifier as an argument.

6. The method of claim 1, wherein distributing the assignments for offloading the plurality of logs across the first monitor and the second monitor comprises:
determining a data collection rate associated with each of plurality of logs; and
distributing the assignments for offloading the plurality of logs across the first monitor and the second monitor based, at least in part, on an analysis of the data collection rates.

7. The method of claim 1 further comprising:
monitoring a log file in the storage device, wherein the log file corresponds to a first of the plurality of logs and comprises compressed data offloaded from the first log; and
based on determining that the log file has exceeded a threshold size,
locking the log file on the storage device;
reading and decompressing the log file;
removing an estimated amount of data from the decompressed log file, wherein the estimated amount of data is determined based, at least in part, on a set of criteria; and
recompressing and storing the log file on the storage device.

8. The method of claim 7, wherein the set of criteria comprises at least one of a type of compression technique used to compress data in the log file, an amount with which the log file exceeds the threshold size, a decompressed size of the log file, and a configured amount of buffer space to be allotted for new log data.

9. The method of claim 7 further comprising:
determining a number of instances that the log file has exceeded the threshold size over a period of time; and
based on determining that the number of instances exceeds a threshold, increasing the estimated amount of data to remove from the decompressed log file.

10. One or more non-transitory machine-readable media comprising program code for managing a scalable logging system, the program code to:
detect a plurality of logs in memory of a first system, wherein each log of the plurality of logs comprises data collected from a network device;
instantiate a first monitor and a second monitor;
distribute assignments for offloading the plurality of logs from the memory to a storage device across the first monitor and the second monitor; and
based on a determination that the first monitor and the second monitor do not satisfy performance criteria,
instantiate a third monitor; and
redistribute assignments for offloading the plurality of logs across the first monitor, the second monitor, and the third monitor.

11. The machine-readable media of claim 10 further comprising program code to:
offload, by the first monitor, a first log of the plurality of logs from the memory of the first system to the storage device, wherein the program code to offload the first log comprises program code to,
detect a trigger for offloading the first log; and
based on detection of the trigger,
remove the first log from the memory;
compress the first log; and
append the compressed first log to a log file corresponding to the first log in the storage device.

12. An apparatus comprising:
a processor; and
a machine-readable medium having program code executable by the processor to cause the apparatus to,
detect a plurality of logs in memory of a first system, wherein each log of the plurality of logs comprises data collected from a network device;
instantiate a first monitor and a second monitor;
distribute assignments for offloading the plurality of logs from the memory to a storage device across the first monitor and the second monitor; and
based on a determination that the first monitor and the second monitor do not satisfy performance criteria,
instantiate a third monitor; and
redistribute assignments for offloading the plurality of logs across the first monitor, the second monitor, and the third monitor.

13. The apparatus of claim 12, further comprising program code executable by the processor to cause the apparatus to:
offload, by the first monitor, a first log of the plurality of logs from the memory of the first system to the storage device, wherein the program code executable by the processor to cause the apparatus to offload the first log comprises program code executable by the processor to cause the apparatus to,
detect a trigger for offloading the first log; and
based on detection of the trigger,
remove the first log from the memory;
compress the first log; and
append the compressed first log to a log file corresponding to the first log in the storage device.

14. The apparatus of claim 13, wherein the program code executable by the processor to cause the apparatus to detect the trigger for offloading the first log comprises program code executable by the processor to cause the apparatus to at least one of:
determine that the first log has exceeded a threshold size;
receive a request to offload the first log;
complete offloading of a second log of the plurality of logs; and
determine that a period of time has elapsed since the first log was previously offloaded.

15. The apparatus of claim 12, wherein the program code executable by the processor to cause the apparatus to determine that the first monitor and the second monitor satisfy the performance criteria comprises program code executable by the processor to cause the apparatus to at least one of:
determine that the first monitor and the second monitor are consuming more than an allotted amount of resources on the first system;
determine that the first monitor and the second monitor are not offloading a threshold number of logs within a time period; and
determine that the first monitor and the second monitor are not maintaining each of the plurality of logs below a threshold size.

16. The apparatus of claim 12, wherein the program code executable by the processor to cause the apparatus to distribute the assignments for offloading the plurality of logs across the first monitor and the second monitor comprises program code executable by the processor to cause the apparatus to:
for each of plurality of logs,
determine an identifier for the log; and
determine whether to assign the log to the first monitor or the second monitor based, at least in part, on evaluating a function that uses the identifier as an argument.

17. The apparatus of claim 12, wherein the program code executable by the processor to cause the apparatus to distribute the assignments for offloading the plurality of logs across the first monitor and the second monitor comprises program code executable by the processor to cause the apparatus to:
determine a data collection rate associated with each of plurality of logs; and
distribute the assignments for offloading the plurality of logs across the first monitor and the second monitor based, at least in part, on an analysis of the data collection rates.

18. The apparatus of claim 12 further comprising program code executable by the processor to cause the apparatus to:
monitor a log file in the storage device, wherein the log file corresponds to a first of the plurality of logs and comprises compressed data offloaded from the first log; and
based on a determination that the log file has exceeded a threshold size,
lock the log file on the storage device;
read and decompress the log file;
remove an estimated amount of data from the decompressed log file, wherein the estimated amount of data is determined based, at least in part, on a set of criteria; and
recompress and store the log file on the storage device.

19. The apparatus of claim 18, wherein the set of criteria comprises at least one of a type of compression technique used to compress data in the log file, an amount with which the log file exceeds the threshold size, a decompressed size of the log file, and a configured amount of buffer space to be allotted for new log data.

20. The apparatus of claim 18 further comprising program code executable by the processor to cause the apparatus to:
determine a number of instances that the log file has exceeded the threshold size over a period of time; and
based on a determination that the number of instances exceeds a threshold, increase the estimated amount of data to remove from the decompressed log file.
